(19) United States
(12) Patent Application Publication
(10) Pub. No.: US 2026/0251498 A1
(43) Pub. Date: Aug. 27, 2026

(54) METHOD AND SYSTEM FOR PREDICTING AMBIENT ILLUMINANCE

(71) Applicant: Realtek Semiconductor Corporation, Hsinchu (TW)

(72) Inventors: Shi-Hao LI, Hsinchu (TW); Pao-Chi YEH, Hsinchu (TW)

(21) Appl. No.: 19/530,326

(22) Filed: Feb. 4, 2026

(30) Foreign Application Priority Data
Feb. 26, 2025 (TW) 114107026

(51) Int. Cl. G01J 1/42; G06F 1/3234; G06V 20/00; G06V 40/10; G09G 3/34

(52) U.S. Cl. CPC G01J 1/4204; G06V 20/35; G06V 40/103; G09G 3/3406; G06F 1/3265; G09G 2320/0626

(57) ABSTRACT

A method for predicting ambient illuminance includes: obtaining image data of a tested environment by an image sensor; performing an automatic exposure on the image data to obtain an exposure time and a gain used by the image sensor when obtaining the image data; multiplying the exposure time by the gain and then getting reciprocal of the multiplied value to obtain a computed value; identifying a scene category and a human shape and skin color category corresponding to the tested environment based on the image data; configuring a leading coefficient and an exponential coefficient according to the scene category and the human shape and skin color category; and substituting the computed value, the leading coefficient, and the exponential coefficient into equation: A×X^{B}, to obtain a predicted illuminance of the tested environment. X is the computed value, A is the leading coefficient, and B is the exponential coefficient.

### CROSS-REFERENCE TO RELATED APPLICATION

This application claims priority to Taiwan Application Serial Number 114107026, filed Feb. 26, 2025, which is herein incorporated by reference in its entirety.

### BACKGROUND

### Field of Invention

The present disclosure relates to a method and a system for predicting ambient illuminance. More particularly, the present disclosure relates to a method and a system for predicting ambient illuminance based on a camera.

### Description of Related Art

An ambient light sensor (ALS) is an optical sensor mainly used to detect the amount of ambient light and is widely applied in handheld electronic devices such as mobile phones and notebook computers. When the lights are turned off indoors or in a dim environment, if the screen brightness of the handheld electronic device is too high, it will make the human eye feel uncomfortable. At this time, the screen brightness can be adjusted to a brightness range that is more comfortable for the human eye based on the amount of ambient light sensed by the ALS to improve the user experience. On the other hand, proper adjustment of the screen brightness can also reduce the power consumption of the handheld electronic devices, thereby extending the battery life.

The ALS can be implemented by using a variety of different components. Traditionally, the photoresistor is commonly used to implement the ALS because the photoresistor has the advantages of low cost and small size. However, because the material of the photoresistor is cadmium sulfide, which is considered as a banned substance in RoHS (Restriction of Hazardous Substances) compliance, the photoresistor is no longer suitable for general commercial applications. The phototransistor is also used to implement the ALS. Although the material of the phototransistor can pass RoHS compliance, when the phototransistor is used as a visible light sensor, this visible light sensor may further receive infrared (IR) light, resulting in an increase in output current, thereby increasing the possibility of misjudgment. Currently, the mainstream component to implement the ALS is the photo IC, which has the advantages of excellent linear curve and spectral characteristics close to the response of the human eye to visible light, but the cost of the photo IC is also the highest among the aforementioned three components.

In general, in order to detect the amount of ambient light to adjust the screen brightness accordingly, the aforementioned handheld electronic devices need to be additionally equipped with the ALS, which will increase the manufacturing cost and the product size of the handheld electronic device. Therefore, how to realize the sense of the amount of ambient light without configuring the ALS has become an issue of concern to those skilled in the art.

### SUMMARY

The present disclosure provides a method for predicting ambient illuminance. The method includes: obtaining image data of a tested environment by utilizing an image sensor; performing an automatic exposure operation on the image data to obtain an exposure time and a gain that the image sensor is used to obtain the image data; multiplying the exposure time by the gain to obtain a multiplied value and then getting a reciprocal of the multiplied value to obtain a computed value; identifying a scene category corresponding to the tested environment based on the image data and identifying a human shape and skin color category corresponding to the tested environment based on the image data; configuring a leading coefficient and an exponential coefficient according to the scene category and the human shape and skin color category; and substituting the computed value, the leading coefficient, and the exponential coefficient into an equation: A×X^{B}, to obtain a predicted illuminance of the tested environment. X is the computed value, A is the leading coefficient, and B is the exponential coefficient.

The present disclosure further provides a system for predicting ambient illuminance. The system includes an image sensor, an image signal processor, a neural network processor, and a data processor. The image sensor is configured to obtain image data of a tested environment. The image signal processor is communicatively connected to the image sensor and configured to receive the image data and perform an automatic exposure operation on the image data to obtain an exposure time and a gain that the image sensor is used to obtain the image data. The neural network processor is communicatively connected to the image signal processor and configured to identify a scene category corresponding to the tested environment based on the image data and identify a human shape and skin color category corresponding to the tested environment based on the image data. The data processor is communicatively connected to the image signal processor and the neural network processor and configured to: multiply the exposure time by the gain to obtain a multiplied value and then get a reciprocal of the multiplied value to obtain a computed value; configure a leading coefficient and an exponential coefficient according to the scene category and the human shape and skin color category; and substitute the computed value, the leading coefficient, and the exponential coefficient into equation: A×X^{B}, to obtain a predicted illuminance of the tested environment. X is the computed value, A is the leading coefficient, and B is the exponential coefficient.

In order to let above features and advantages of the present disclosure to be more easily understood, the following detailed description of the embodiment is provided, with reference made to the accompanying drawings as follows.

### BRIEF DESCRIPTION OF THE DRAWINGS

FIG. 1 is a block diagram of a system for predicting ambient illuminance according to some embodiments of the present disclosure.

FIG. 2 is a flowchart of a method for predicting ambient illuminance according to some embodiments of the present disclosure.

### DETAILED DESCRIPTION

The using of “first”, “second”, etc. in the specification are not intended to mean a sequence or order, and are merely used to distinguish elements or operations described in the same technical terms.

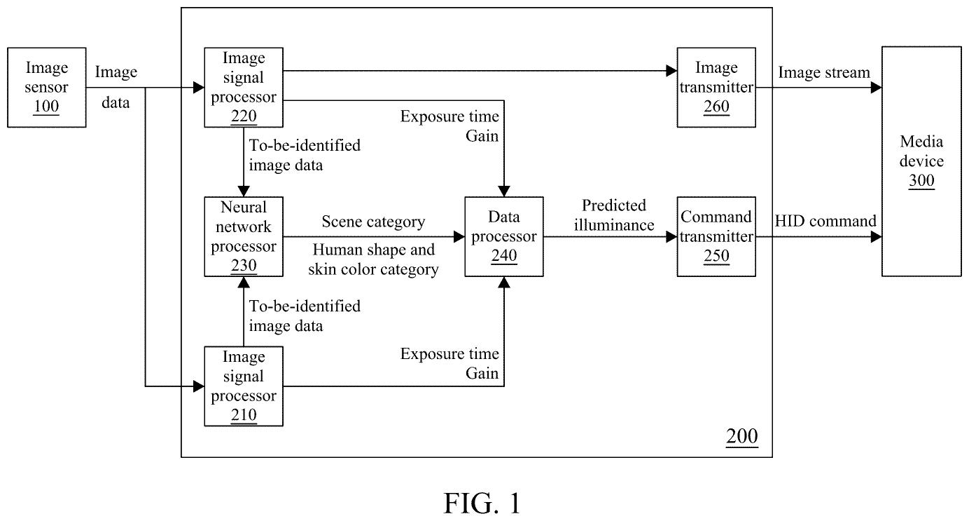

FIG. 1 is a block diagram of a system for predicting ambient illuminance according to some embodiments of the present disclosure. The system for predicting ambient illuminance includes an image sensor 100, a processing circuit 200, and a media device 300. In some embodiments of the present disclosure, the system for predicting ambient illuminance is implemented in handheld electronic devices such as notebook computers, mobile phones, or tablet computers, but the present disclosure is not limited thereto.

The image sensor 100 is used to capture the current environment within its field of view (FOV) to obtain images. The image sensor 100 is mounted on a handheld electronic device (e.g., integrated with a front lens of the handheld electronic device). In some embodiments of the present disclosure, the image sensor 100 is a visible light image sensor, such as a charge coupled device (CCD) image sensor or a complementary metal-oxide semiconductor (CMOS) image sensor.

The processing circuit 200 includes an image signal processor 210, an image signal processor 220, a neural network processor 230, a data processor 240, a command transmitter 250, and an image transmitter 260.

The image signal processor 210 and the image signal processor 220 are communicatively connected to the image sensor 100. The image signal processor 210 or the image signal processor 220 receives image data of a tested environment from the image sensor 100, in which the image data of a tested environment is obtained by utilizing the image sensor 100. The image signal processor 210 or the image signal processor 220 performs an automatic exposure (AE) operation on the image data to obtain an exposure time and a gain that the image sensor 100 is used to obtain the image data.

The image signal processor 210 or the image signal processor 220 further performs downsampling and frame reduction on the image data to obtain to-be-identified image data. The neural network processor 230 is communicatively connected to the image signal processor 210 and the image signal processor 220 to receive the to-be-identified image data from the image signal processor 210 or the image signal processor 220. The neural network processor 230 inputs the to-be-identified image data into a scene identification model to identify a scene category corresponding to the tested environment. The neural network processor 230 further inputs the to-be-identified image data into a human shape and skin color identification model to identify a human shape and skin color category corresponding to the tested environment.

The data processor 240 is communicatively connected to the image signal processor 210, the image signal processor 220, and the neural network processor 230. The data processor 240 receives the exposure time and the gain from the image signal processor 210 or the image signal processor 220. The data processor 240 receives the scene category corresponding to the tested environment and the human shape and skin color category corresponding to the tested environment. The data processor 240 multiplies the exposure time by the gain to obtain a multiplied value and then gets a reciprocal of the multiplied value to obtain a computed value. The data processor 240 further configures a leading coefficient and an exponential coefficient according to the scene category and the human shape and skin color category. The data processor 240 finally substitutes the computed value, the leading coefficient, and the exponential coefficient into an equation: A×X^{B}, to obtain a predicted illuminance of the tested environment, in which X is the computed value, A is the leading coefficient, and B is the exponential coefficient.

In some embodiments of the present disclosure, the command transmitter 250 is a human interface device (HID) interface. The command transmitter 250 is communicatively connected to the data processor 240 and the media device 300. The data processor 240 further generates a human interface device (HID) command according to the predicted illuminance. The data processor 240 further transmits the HID command to the media device 300 through the command transmitter 250 to set a screen brightness of the media device according to the HID command.

In some embodiments of the present disclosure, the image transmitter 260 is a Universal Serial Bus (USB) interface. The image transmitter 260 is communicatively connected to the image signal processor 220 and the media device 300. The image signal processor 220 transmits the image stream corresponding to the image data to the media device 300 through the image transmitter 260, such that the screen of the media device 300 displays image corresponding to the image data.

Specifically, the current handheld electronic device is usually equipped with a front lens adjacent to its screen, and the front lens contains a photosensitive element. When the amount of ambient light entering the front lens is large, which means that the ambient light is brighter, the exposure time and the gain of the image sensor are reduced to solve the problem of image present on the screen being too bright (i.e., the brighter the ambient light, the smaller the exposure time and the gain of the image sensor). On the contrary, when the amount of ambient light entering the front lens is less, the exposure time and the gain of the image sensor are increased so that the image present on the screen can be maintained at an appropriate brightness (i.e., the darker the ambient light, the greater the exposure time and the gain of the image sensor). To sum up, the exposure time and the gain are negatively correlated with the amount of ambient light. Therefore, the present disclosure uses this negative correlation to predict the ambient illuminance from the exposure time and the gain, thereby realizing the function of using the image sensor to predict the ambient illuminance. In this way, the handheld electronic device does not need to be additionally equipped with an ambient light sensor (ALS) for sensing the ambient light, which can further reduce the manufacturing cost and product size of the handheld electronic device.

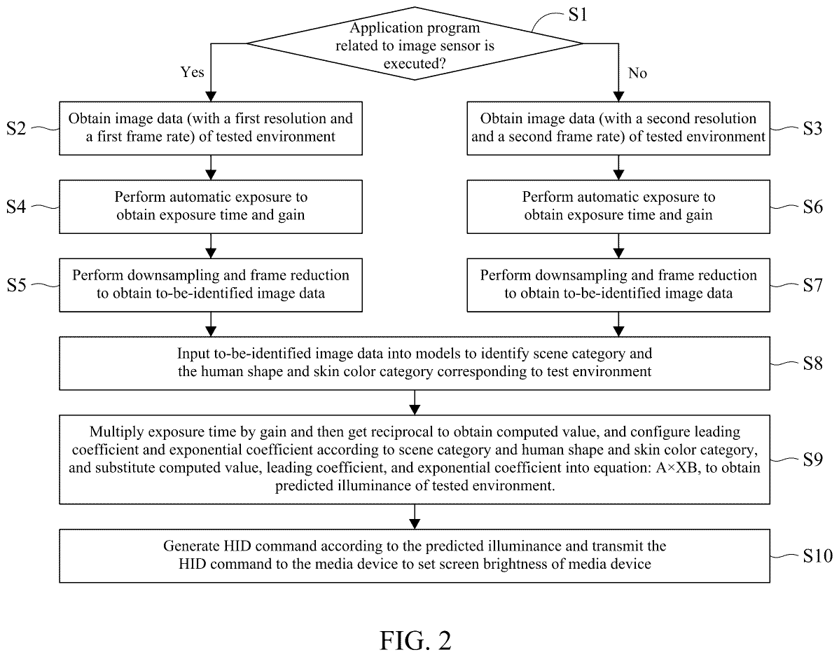

FIG. 2 is a flowchart of a method for predicting ambient illuminance according to some embodiments of the present disclosure. The present disclosure will be described in more detail below with reference to FIG. 1 and FIG. 2. In Step S1, the processing circuit 200 determines whether at least one application program related to the image sensor 100 is executed. The application program as mentioned above is, for example, a video conference software, a photographing software, a communication software, etc. If the determined result of Step S1 is yes, Step S2 is performed. If the determined result of Step S1 is no, Step S3 is performed.

In Step S2, the processing circuit 200 transmits a command to the image sensor 100 so that the image sensor 100 captures the tested environment to obtain the image data of the tested environment, and the image data is transmitted to the image signal processor 220. The image data obtained in Step S2 has a first resolution and a first frame rate.

In Step S3, the processing circuit 200 transmits a command to the image sensor 100 so that the image sensor 100 captures the tested environment to obtain the image data of the tested environment, and the image data is transmitted to the image signal processor 210. The image data obtained in Step S3 has a second resolution and a second frame rate.

In some embodiments of the present disclosure, the first resolution is higher than the second resolution and the first frame rate is higher than the second frame rate. For example, the first resolution may be 1920×1080, the first frame rate may be 30 FPS (frame per second), the second resolution may be 640×480, and the second frame rate may be 3 FPS, but the present disclosure is not limited thereto.

Specifically, regarding Steps S1 and S2, if at least one application program related to the image sensor 100 is executed, it means that the image sensor 100 is operated, so the processing circuit 200 transmits a command to the image sensor 100 to enable the image sensor 100 to obtain the image data with high resolution and high frame rate. In contrast, regarding Steps S1 and S3, if at least one application program related to the image sensor 100 is not executed, the processing circuit 200 transmits a command to the image sensor 100 to enable the image sensor 100 to obtain the image data with low resolution and low frame rate, thereby reducing the subsequent amount of computation.

In Step S4 after Step S2, the image signal processor 220 performs an automatic exposure (AE) operation on the image data to obtain the exposure time and the gain that the image sensor 100 is used to obtain the image data. Specifically, since the image data obtained in Step S2 has the high resolution and the high frame rate, Step S4 not only performs the automatic exposure operation but also performs other complex image processing to generate the processed image data. In addition, the processed image data generated in Step S4 is also transmitted by the image signal processor 220 to the media device 300 in form of image stream via the image transmitter 260 so that the screen of the media device 300 displays image corresponding to the processed image data.

In Step S5 after Step S4, the image signal processor 220 performs downsampling and frame reduction on the processed image data to obtain to-be-identified image data. The to-be-identified image data corresponds to a small-size image. Specifically, the downsampling and frame reduction performed in Step S5 is intended to reduce the amount of computation required for subsequent identification (i.e., Step S8).

In Step S6 after Step S3, the image signal processor 210 performs an automatic exposure operation on the image data to obtain the exposure time and the gain that the image sensor 100 is used to obtain the image data. Specifically, since the image data obtained in Step S3 has the low resolution and the low frame rate, Step S6 not only performs the automatic exposure operation but also performs other simple image processing to generate the processed image data.

In Step S7 after Step S6, the image signal processor 210 performs downsampling and frame reduction on the processed image data to obtain to-be-identified image data. The to-be-identified image data corresponds to a small-size image. Specifically, the downsampling and frame reduction performed in Step S7 is intended to reduce the amount of computation required for subsequent identification (i.e., Step S8).

In Step S8 after Step S5 or Step S7, the neural network processor 230 inputs the to-be-identified image data into the scene identification model to identify the scene category corresponding to the tested environment, and the neural network processor 230 inputs the to-be-identified image data into the human shape and skin color identification model to identify the human shape and skin color category corresponding to the tested environment.

In some embodiments of the present disclosure, the scene identification model adopts the MobileNet architecture, but the present disclosure is not limited thereto. The MobileNet architecture can effectively reduce the amount of computation and parameters through depthwise separable convolution (DSC), and is suitable for hardware environments with limited resources. The input of the scene identification model is the to-be-identified image data, and the output of the scene identification model is the scene category. In some embodiments of the present disclosure, the scene category corresponding to the tested environment is one of following: a backlight scene, a front light scene, an office scene, and a low light scene.

In some embodiments of the present disclosure, the human shape and skin color identification model adopts the YOLOv4-tiny architecture, but the present disclosure is not limited thereto. The YOLOv4-tiny architecture is a compressed/simplified version of YOLOv4 architecture. The YOLOv4-tiny architecture can significantly reduce the model size and requirements of computation while maintaining a certain identification capability. The input of the human shape and skin color identification model is the to-be-identified image data, and the output of the human shape and skin color identification model is the human shape and skin color category. In some embodiments of the present disclosure, the human shape and skin color category corresponding to the tested environment is one of following: a non-existence, a light skin, a medium skin, and a dark skin.

In Step S9 after Step S8, the data processor 240 multiplies the exposure time by the gain to obtain a multiplied value and then gets a reciprocal of the multiplied value to obtain a computed value, and the data processor 240 configures the leading coefficient and the exponential coefficient according to the scene category and the human shape and skin color category. Finally, the computed value, the leading coefficient, and the exponential coefficient are substituted into an equation: A×X^{B}, to obtain the predicted illuminance of the tested environment. X is the computed value, A is the leading coefficient, and B is the exponential coefficient.

In Step S10 after Step S9, the data processor 240 generates the HID command according to the predicted illuminance, and transmits the HID command to the media device 300 through the command transmitter 250 to set the screen brightness of the media device 300 according to the HID command.

In some embodiments of the present disclosure, the predicted illuminance is positively correlated to the screen brightness of the media device 300. Specifically, when the predicted illuminance is larger, it means that the ambient light is brighter, so the screen brightness of the media device 300 should be increased so that the user can see image present on the screen. In contrast, when the predicted illuminance is smaller, it means that the ambient light is darker, so the screen brightness of the media device 300 should be reduced so that the user can see image present on the screen more comfortably and the effect of saving power can be achieved.

It is worth mentioning that the reason that the data processor 240 configures the leading coefficient and the exponential coefficient according to the scene category and the human shape and skin color category in Step S9 is that it has been found through actual measurements that different scene categories and different human shape and skin color categories require different leading coefficients and different exponential coefficients to make the predicted illuminance closer to the actual ambient illuminance.

Accordingly, the data processor 240 needs to pre-perform the following solving operation to calculate the leading coefficient and the exponential coefficient corresponding to each scene category and each human shape and skin color category. The aforementioned solving operation process is described as follows. (a1) A standard instrument that can obtain the amount of ambient light (i.e., a lux meter) is used to obtain plural ambient illuminances (e.g., 100 lux, 400 lux, 800 lux, and 1200 lux, but the present disclosure is not limited thereto) respectively corresponding to plural sets of solving-purposed environments. Each of the aforementioned sets of solving-purposed environments corresponds to a certain scene category and a certain human shape and skin color category. (a2) The image sensor 100 obtains plural solving-purposed image data respectively corresponding to the aforementioned sets of solving-purposed environments. In other words, the image sensor 100 captures the aforementioned sets of solving-purposed environments to obtain plural solving-purposed image data respectively corresponding to the aforementioned sets of solving-purposed environments. (a3) An automatic exposure operation is performed on the aforementioned solving-purposed image data to obtain the exposure time and the gain corresponding to each of the aforementioned solving-purposed image data. (a4) The exposure time corresponding to each of the solving-purposed image data is multiplied by the gain corresponding to each of the solving-purposed image data to obtain plural multiplied results, and then reciprocals of the multiplied results are got to obtain plural solving-purposed computed values. (a5) The solving-purposed computed values are respectively substituted into an equation: α×Y^{β}, to obtain plural solving-purposed illuminances. Y is one of the solving-purposed computed values, α is a to-be-determined leading coefficient, and β is a to-be-determined exponential coefficient. (a6) A minimum error analysis is performed on the ambient illuminances and the solving-purposed illuminances according to the sets of solving-purposed environments respectively corresponding to the ambient illuminances so as to solve the to-be-determined leading coefficient and the to-be-determined exponential coefficient that minimize error between the ambient illuminances and the solving-purposed illuminances, thereby serving as the leading coefficient and the exponential coefficient corresponding to the certain scene category and the certain human shape and skin color category.

The aforementioned minimum error analysis can be performed by the following equation:

$$Minimize error = {\sum }_{i = 1}^{n} ( ambient {illuminance}_{i} - {α}_{i} * {Y}^{{β}_{i}} ) .$$

Please note that n is the number of the solving-purposed environments. For example, if the ambient illuminances are 100 lux, 400 lux, 800 lux, and 1200 lux, then n=4. Specifically, the purpose of the aforementioned solving operation is to make the solving-purposed illuminances as close to the ambient illuminance as possible, so the minimum error analysis is adopts to solve the leading coefficient and the exponential coefficient, and the solved leading coefficient and the solved exponential coefficient can make the predicted illuminance close to the actual ambient illuminance.

In one aspect of the present disclosure, a method for predicting ambient illuminance is disclosed. The method includes: obtaining image data of a tested environment by utilizing an image sensor; performing an automatic exposure operation on the image data to obtain an exposure time and a gain that the image sensor is used to obtain the image data; multiplying the exposure time by the gain to obtain a multiplied value and then getting a reciprocal of the multiplied value to obtain a computed value; identifying a scene category corresponding to the tested environment based on the image data and identifying a human shape and skin color category corresponding to the tested environment based on the image data; configuring a leading coefficient and an exponential coefficient according to the scene category and the human shape and skin color category; and substituting the computed value, the leading coefficient, and the exponential coefficient into an equation: A×X^{B}, to obtain a predicted illuminance of the tested environment. X is the computed value, A is the leading coefficient, and B is the exponential coefficient.

In some embodiments of the present disclosure, the method further includes: determining whether at least one application program related to the image sensor is executed; controlling the image sensor to obtain the image data with a first resolution and a first frame rate, in response to the at least one application program being executed; and controlling the image sensor to obtain the image data with a second resolution and a second frame rate, in response to the at least one application program being not executed. The first resolution is higher than the second resolution and the first frame rate is higher than the second frame rate. In some embodiments of the present disclosure, the method further includes: generating a human interface device (HID) command according to the predicted illuminance; and setting a screen brightness of a media device according to the HID command. In some embodiments of the present disclosure, the predicted illuminance is positively correlated to the screen brightness of the media device. In some embodiments of the present disclosure, the method further includes: performing downsampling and frame reduction on the image data to obtain to-be-identified image data; inputting the to-be-identified image data into a scene identification model to identify the scene category corresponding to the tested environment; and inputting the to-be-identified image data into a human shape and skin color identification model to identify the human shape and skin color category corresponding to the tested environment. In some embodiments of the present disclosure, the scene category corresponding to the tested environment is one of following: a backlight scene, a front light scene, an office scene, and a low light scene. In some embodiments of the present disclosure, the human shape and skin color category corresponding to the tested environment is one of following: a non-existence, a light skin, a medium skin, and a dark skin. In some embodiments of the present disclosure, the leading coefficient and the exponential coefficient are pre-obtained by following operations: using a lux meter to obtain a plurality of ambient illuminances respectively corresponding to a plurality of sets of solving-purposed environments, in which each of the plurality of sets of the solving-purposed environments corresponds to a certain scene category and a certain human shape and skin color category; obtaining, by the image sensor, a plurality of solving-purposed image data respectively corresponding to the plurality of sets of solving-purposed environments; performing the automatic exposure operation on the plurality of solving-purposed image data to obtain the exposure time and the gain corresponding to each of the plurality of solving-purposed image data; multiplying the exposure time corresponding to each of the plurality of solving-purposed image data by the gain corresponding to each of the plurality of solving-purposed image data to obtain a plurality of multiplied results and then getting reciprocals of the multiplied results to obtain a plurality of solving-purposed computed values; substituting the plurality of solving-purposed computed values into an equation: α×Y^{β}, to obtain a plurality of solving-purposed illuminances, in which Y is one of the plurality of solving-purposed computed values, α is a to-be-determined leading coefficient, and β is a to-be-determined exponential coefficient; and performing a minimum error analysis on the plurality of ambient illuminances and the plurality of solving-purposed illuminances according to the plurality of sets of solving-purposed environments respectively corresponding to the plurality of ambient illuminances so as to solve the to-be-determined leading coefficient and the to-be-determined exponential coefficient that minimize error between the plurality of ambient illuminances and the plurality of solving-purposed illuminances, thereby serving as the leading coefficient and the exponential coefficient corresponding to the certain scene category and the certain human shape and skin color category.

In another aspect of the present disclosure, a system for predicting ambient illuminance is disclosed. The system includes an image sensor, an image signal processor, a neural network processor, and a data processor. The image sensor is configured to obtain image data of a tested environment. The image signal processor is communicatively connected to the image sensor and configured to receive the image data and perform an automatic exposure operation on the image data to obtain an exposure time and a gain that the image sensor is used to obtain the image data. The neural network processor is communicatively connected to the image signal processor and configured to identify a scene category corresponding to the tested environment based on the image data and identify a human shape and skin color category corresponding to the tested environment based on the image data. The data processor is communicatively connected to the image signal processor and the neural network processor and configured to: multiply the exposure time by the gain to obtain a multiplied value and then get a reciprocal of the multiplied value to obtain a computed value; configure a leading coefficient and an exponential coefficient according to the scene category and the human shape and skin color category; and substitute the computed value, the leading coefficient, and the exponential coefficient into equation: A×X^{B}, to obtain a predicted illuminance of the tested environment. X is the computed value, A is the leading coefficient, and B is the exponential coefficient.

In some embodiments of the present disclosure, the system further includes a command transmitter and a media device. The command transmitter is communicatively connected to the data processor. The media device communicatively connected to the command transmitter. The data processor is further configured to: generate a human interface device (HID) command according to the predicted illuminance; and transmit the HID command to the media device through the command transmitter to set a screen brightness of the media device according to the HID command. In some embodiments of the present disclosure, the predicted illuminance is positively correlated to the screen brightness of the media device. In some embodiments of the present disclosure, the image signal processor is further configured to perform downsampling and frame reduction on the image data to obtain to-be-identified image data. The neural network processor receives the to-be-identified image data to: input the to-be-identified image data into a scene identification model to identify the scene category corresponding to the tested environment; and input the to-be-identified image data into a human shape and skin color identification model to identify the human shape and skin color category corresponding to the tested environment. In some embodiments of the present disclosure, the scene category corresponding to the tested environment is one of following: a backlight scene, a front light scene, an office scene, and a low light scene. In some embodiments of the present disclosure, the human shape and skin color category corresponding to the tested environment is one of following: a non-existence, a light skin, a medium skin, and a dark skin. In some embodiments of the present disclosure, the leading coefficient and the exponential coefficient are pre-obtained by the data processor through following operations: using a lux meter to obtain a plurality of ambient illuminances respectively corresponding to a plurality of sets of solving-purposed environments, in which each of the plurality of sets of the solving-purposed environments corresponds to a certain scene category and a certain human shape and skin color category; obtaining, by the image sensor, a plurality of solving-purposed image data respectively corresponding to the plurality of sets of solving-purposed environments; performing the automatic exposure operation on the plurality of solving-purposed image data to obtain the exposure time and the gain corresponding to each of the plurality of solving-purposed image data; multiplying the exposure time corresponding to each of the plurality of solving-purposed image data by the gain corresponding to each of the plurality of solving-purposed image data to obtain a plurality of multiplied results and then getting reciprocals of the multiplied results to obtain a plurality of solving-purposed computed values; substituting the plurality of solving-purposed computed values into an equation: α×Y^{β}, to obtain a plurality of solving-purposed illuminances, in which Y is one of the plurality of solving-purposed computed values, α is a to-be-determined leading coefficient, and β is a to-be-determined exponential coefficient; and performing a minimum error analysis on the plurality of ambient illuminances and the plurality of solving-purposed illuminances according to the plurality of sets of solving-purposed environments respectively corresponding to the plurality of ambient illuminances so as to solve the to-be-determined leading coefficient and the to-be-determined exponential coefficient that minimize error between the plurality of ambient illuminances and the plurality of solving-purposed illuminances, thereby serving as the leading coefficient and the exponential coefficient corresponding to the certain scene category and the certain human shape and skin color category.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A method for predicting ambient illuminance, comprising:
obtaining image data of a tested environment by utilizing an image sensor;
performing an automatic exposure operation on the image data to obtain an exposure time and a gain that the image sensor is used to obtain the image data;
multiplying the exposure time by the gain to obtain a multiplied value and then getting a reciprocal of the multiplied value to obtain a computed value;
identifying a scene category corresponding to the tested environment based on the image data and identifying a human shape and skin color category corresponding to the tested environment based on the image data;
configuring a leading coefficient and an exponential coefficient according to the scene category and the human shape and skin color category; and
substituting the computed value, the leading coefficient, and the exponential coefficient into an equation: A×X^{B}, to obtain a predicted illuminance of the tested environment, wherein X is the computed value, A is the leading coefficient, and B is the exponential coefficient.

2. The method for predicting ambient illuminance of claim 1, further comprising:
determining whether at least one application program related to the image sensor is executed;
controlling the image sensor to obtain the image data with a first resolution and a first frame rate, in response to the at least one application program being executed; and
controlling the image sensor to obtain the image data with a second resolution and a second frame rate, in response to the at least one application program being not executed;
wherein the first resolution is higher than the second resolution and the first frame rate is higher than the second frame rate.

3. The method for predicting ambient illuminance of claim 1, further comprising:
generating a human interface device (HID) command according to the predicted illuminance; and
setting a screen brightness of a media device according to the HID command.

4. The method for predicting ambient illuminance of claim 3, wherein the predicted illuminance is positively correlated to the screen brightness of the media device.

5. The method for predicting ambient illuminance of claim 1, further comprising:
performing downsampling and frame reduction on the image data to obtain to-be-identified image data;
inputting the to-be-identified image data into a scene identification model to identify the scene category corresponding to the tested environment; and
inputting the to-be-identified image data into a human shape and skin color identification model to identify the human shape and skin color category corresponding to the tested environment.

6. The method for predicting ambient illuminance of claim 1, wherein the scene category corresponding to the tested environment is one of following: a backlight scene, a front light scene, an office scene, and a low light scene.

7. The method for predicting ambient illuminance of claim 5, wherein the human shape and skin color category corresponding to the tested environment is one of following: a non-existence, a light skin, a medium skin, and a dark skin.

8. The method for predicting ambient illuminance of claim 1, wherein the leading coefficient and the exponential coefficient are pre-obtained by following operations:
using a lux meter to obtain a plurality of ambient illuminances respectively corresponding to a plurality of sets of solving-purposed environments, wherein each of the plurality of sets of the solving-purposed environments corresponds to a certain scene category and a certain human shape and skin color category;
obtaining, by the image sensor, a plurality of solving-purposed image data respectively corresponding to the plurality of sets of solving-purposed environments;
performing the automatic exposure operation on the plurality of solving-purposed image data to obtain the exposure time and the gain corresponding to each of the plurality of solving-purposed image data;
multiplying the exposure time corresponding to each of the plurality of solving-purposed image data by the gain corresponding to each of the plurality of solving-purposed image data to obtain a plurality of multiplied results and then getting reciprocals of the multiplied results to obtain a plurality of solving-purposed computed values;
substituting the plurality of solving-purposed computed values into an equation: α×Y^{β}, to obtain a plurality of solving-purposed illuminances, wherein Y is one of the plurality of solving-purposed computed values, α is a to-be-determined leading coefficient, and β is a to-be-determined exponential coefficient; and
performing a minimum error analysis on the plurality of ambient illuminances and the plurality of solving-purposed illuminances according to the plurality of sets of solving-purposed environments respectively corresponding to the plurality of ambient illuminances so as to solve the to-be-determined leading coefficient and the to-be-determined exponential coefficient that minimize error between the plurality of ambient illuminances and the plurality of solving-purposed illuminances, thereby serving as the leading coefficient and the exponential coefficient corresponding to the certain scene category and the certain human shape and skin color category.

9. A system for predicting ambient illuminance, comprising:
an image sensor configured to obtain image data of a tested environment;
an image signal processor communicatively connected to the image sensor and configured to receive the image data and perform an automatic exposure operation on the image data to obtain an exposure time and a gain that the image sensor is used to obtain the image data;
a neural network processor communicatively connected to the image signal processor and configured to identify a scene category corresponding to the tested environment based on the image data and identify a human shape and skin color category corresponding to the tested environment based on the image data; and
a data processor communicatively connected to the image signal processor and the neural network processor and configured to:
multiply the exposure time by the gain to obtain a multiplied value and then get a reciprocal of the multiplied value to obtain a computed value;
configure a leading coefficient and an exponential coefficient according to the scene category and the human shape and skin color category; and
substitute the computed value, the leading coefficient, and the exponential coefficient into an equation: A×X^{B}, to obtain a predicted illuminance of the tested environment, wherein X is the computed value, A is the leading coefficient, and B is the exponential coefficient.

10. The system for predicting ambient illuminance of claim 9, further comprising:
a command transmitter communicatively connected to the data processor; and
a media device communicatively connected to the command transmitter;
wherein the data processor is further configured to:
generate a human interface device (HID) command according to the predicted illuminance; and
transmit the HID command to the media device through the command transmitter to set a screen brightness of the media device according to the HID command.

11. The system for predicting ambient illuminance of claim 10, wherein the predicted illuminance is positively correlated to the screen brightness of the media device.

12. The system for predicting ambient illuminance of claim 9, wherein the image signal processor is further configured to perform downsampling and frame reduction on the image data to obtain to-be-identified image data, wherein the neural network processor receives the to-be-identified image data to:
input the to-be-identified image data into a scene identification model to identify the scene category corresponding to the tested environment; and
input the to-be-identified image data into a human shape and skin color identification model to identify the human shape and skin color category corresponding to the tested environment.

13. The system for predicting ambient illuminance of claim 9, wherein the scene category corresponding to the tested environment is one of following: a backlight scene, a front light scene, an office scene, and a low light scene.

14. The system for predicting ambient illuminance of claim 9, wherein the human shape and skin color category corresponding to the tested environment is one of following: a non-existence, a light skin, a medium skin, and a dark skin.

15. The system for predicting ambient illuminance of claim 9, wherein the leading coefficient and the exponential coefficient are pre-obtained by the data processor through following operations:
using a lux meter to obtain a plurality of ambient illuminances respectively corresponding to a plurality of sets of solving-purposed environments, wherein each of the plurality of sets of the solving-purposed environments corresponds to a certain scene category and a certain human shape and skin color category;
obtaining, by the image sensor, a plurality of solving-purposed image data respectively corresponding to the plurality of sets of solving-purposed environments;
performing the automatic exposure operation on the plurality of solving-purposed image data to obtain the exposure time and the gain corresponding to each of the plurality of solving-purposed image data;
multiplying the exposure time corresponding to each of the plurality of solving-purposed image data by the gain corresponding to each of the plurality of solving-purposed image data to obtain a plurality of multiplied results and then getting reciprocals of the multiplied results to obtain a plurality of solving-purposed computed values;
substituting the plurality of solving-purposed computed values into an equation: α×Y^{β}, to obtain a plurality of solving-purposed illuminances, wherein Y is one of the plurality of solving-purposed computed values, α is a to-be-determined leading coefficient, and β is a to-be-determined exponential coefficient; and
performing a minimum error analysis on the plurality of ambient illuminances and the plurality of solving-purposed illuminances according to the plurality of sets of solving-purposed environments respectively corresponding to the plurality of ambient illuminances so as to solve the to-be-determined leading coefficient and the to-be-determined exponential coefficient that minimize error between the plurality of ambient illuminances and the plurality of solving-purposed illuminances, thereby serving as the leading coefficient and the exponential coefficient corresponding to the certain scene category and the certain human shape and skin color category.
